(19) United States
(12) Patent Application Publication
(10) Pub. No.: US 2007/0160262 A1
(43) Pub. Date: Jul. 12, 2007

(54) Score fusion method and apparatus

(75) Inventors: Junmo Kim, Seoul (KR); Gyu-tae Park, Anyang-si (KR); Jong-ha Lee, Hwaseong-si (KR); Seok-cheol Kee, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/544,643

(22) Filed: Oct. 10, 2006

(30) Foreign Application Priority Data
Jan. 11, 2006 (KR) 10-2006-0003326

(51) Int. Cl. G06K 9/00

(52) U.S. Cl. 382/100

(57) ABSTRACT

A score fusion method and apparatus. The score fusion method includes receiving a plurality of scores respectively obtained by a plurality of classifiers, and fusing the received scores using a likelihood ratio. The score fusion apparatus includes a fusion unit which receives a plurality of scores respectively obtained by a plurality of classifiers and fuses the received scores using a likelihood ratio, and a parameter providing unit which provides the fusion unit with a plurality of parameters needed for fusing the received scores.

### CROSS-REFERENCE TO RELATED APPLICATION

This application claims priority from Korean Patent Application No. 10-2006-0003326 filed on Jan. 11, 2006 in the Korean Intellectual Property Office, the disclosure of which is incorporated herein by reference.

### BACKGROUND OF THE INVENTION

1. Field of the Invention

The present invention relates to score fusion and, more particularly, to a score fusion method and apparatus which can integrate a plurality of classifiers into a single classifier by fusing a plurality of scores respectively output by the plurality of classifiers.

2. Description of Related Art

With the development of the information society, the importance of identification technology to identify individuals has rapidly grown, and more research has been conducted on biometric technology for protecting computer-based personal information and identifying individuals using the characteristics of the human body. Examples of biometric technology include face recognition, speaker verification, fingerprint recognition, and iris recognition, and research has been vigorously conducted to develop a variety of recognition algorithms for the same type of biometric techniques. For example, principal component analysis (PCA) and linear discriminant analysis (LDA) have been developed for face recognition, and a variety of PCA- or LDA-based face recognition algorithms have been suggested.

Classifiers are algorithms or devices that perform various recognition functions including a biometric function. Generally, there are no perfect features for recognition. Thus, there is a limit in how much the performance of recognition can be improved using a single classifier. However, performance can be improved when results from plural classifiers are used. Accordingly, there is a need to integrate a plurality of classifiers into a single classifier. The integration of a plurality of classifiers is related to the fusion of a plurality of scores obtained by the plurality of classifiers using input data.

The relationship between the integration of a plurality of classifiers and the fusion of a plurality of scores respectively obtained by the plurality of classifiers and a conventional score fusion method are taught by A. Jain, K. Nandakumar, and A. Ross in an article entitled “Score Normalization in Multimodal Biometric Systems”. A conventional score fusion method using a weighted summation rule is taught by A. Jain and A. Ross in an article entitled “Learning User-Specific Parameters in a Multibiometric System”. In the weighted sum rule-based score fusion method, however, it is difficult to determine a weight value to be applied to a plurality of scores respectively obtained by a plurality of classifiers.

### BRIEF SUMMARY

An aspect of the present invention provides a score fusion method and apparatus which accompany less computation, but are deemed optimized from the viewpoint of probability theory.

According to an aspect of the present invention, there is provided a score fusion method. The score fusion method includes receiving a plurality of scores respectively obtained by a plurality of classifiers, and fusing the received scores using a likelihood ratio between a distribution of first scores obtained by each of the classifiers using a plurality of input data that render a same object and a distribution of second scores obtained by each of the classifiers using a plurality of input data that render different objects.

According to another aspect of the present invention, there is provided a score fusion apparatus. The score fusion apparatus includes a fusion unit which receives a plurality of scores respectively obtained by a plurality of classifiers and fuses the received scores using a likelihood ratio between a distribution of first scores obtained by each of the classifiers using a plurality of input data that render a same object and a distribution of second scores obtained by each of the classifiers using a plurality of input data that render different objects, and a parameter providing unit which provides the fusion unit with a plurality of parameters needed for fusing the received scores.

According to another aspect of the present invention, there is provided a score fusion method. The score fusion method includes receiving a plurality of scores respectively obtained by a plurality of classifiers, and fusing the received scores using weighted summation based on equal error rates (EERs) of the classifiers.

According to another aspect of the present invention, there is provided a score fusion apparatus. The score fusion apparatus includes a fusion unit which receives a plurality of scores respectively obtained by a plurality of classifiers and fuses the received scores according to weighed summation based on equal error rates (EERs) of the classifiers, and a parameter providing unit which provides the EERs of the classifiers.

According to another aspect of the present invention, there is provided a score fusion apparatus including a plurality of classifiers, each classifier respectively analyzing features of input reference data and input test data and calculating a score, based on a comparison of results of the analysis, indicating how similar the reference data is to the test data, and a fusion unit fusing the plurality of scores to yield a final score using a likelihood ratio or using a weighted summation based on equal error rates (EERs) of the classifiers.

According to another aspect of the present invention, there is provided a method of integrating a plurality of classifiers each of which analyzes features of input data and calculating a score indicating a similarity of the data. The method includes fusing the plurality of scores to yield a final score using a likelihood ratio between a distribution of first scores obtained by each of the classifiers using a plurality of input data that render a same object and a distribution of second scores obtained by each of the classifiers using a plurality of input data that render different objects or using a weighted summation based on equal error rates (EERs) of the classifiers.

According to other aspects of the present invention, there are provided computer readable storage media encoded with processing instructions for causing a processor to execute the aforementioned methods.

Additional and/or other aspects and advantages of the present invention will be set forth in part in the description which follows and, in part, will be obvious from the description, or may be learned by practice of the invention

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram of a score fusion apparatus according to an embodiment of the present invention; and

FIG. 2 is a flowchart illustrating a score fusion method according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

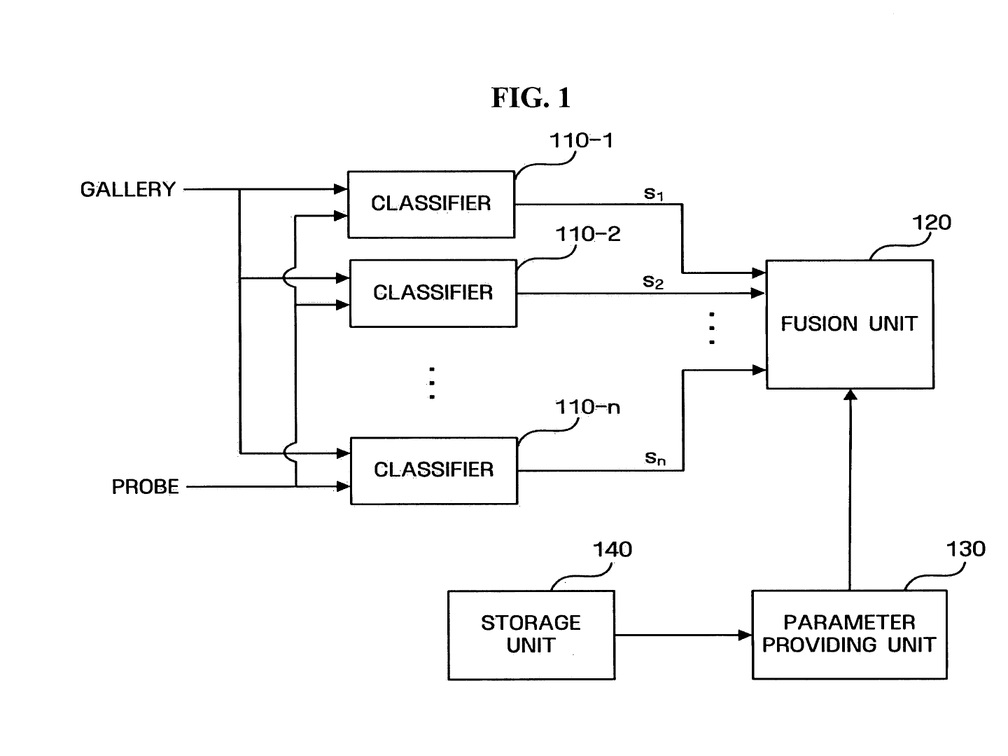

FIG. 1 is a block diagram of a score fusion apparatus according to an embodiment of the present invention. Referring to FIG. 1, the score fusion apparatus includes a plurality of classifiers 110-1 through 110-n, a fusion unit 120, a parameter providing unit 130, and a storage unit 140.

Each of the classifiers 110-1 through 110-n analyzes features of input data, and classifies the input data according to the results of the analysis. In detail, each of the classifiers 110-1 through 110-n analyzes features of two different input data, compares the results of the analysis, and calculates a score. Here, the score is a measure of a similarity between the two different input data. One of the two different input data is reference data, and the other input data is test data that needs to be tested for whether the test data renders the same object as the reference data. The reference data will hereinafter be referred to as a gallery, and the test data will hereinafter be referred to as a probe.

The classifiers 110-1 through 110-n may be applied to, by way of non-limiting examples, a face recognition apparatus or a speaker verification apparatus. For example, when the classifiers 110-1 through 110-n are applied to a face recognition apparatus, each of the classifiers 110-1 through 110-n receives a probe face image and a gallery face image, analyzes features of the probe face image and the gallery face image, and calculates a score indicating how much the probe face image is similar to the gallery face image according to the results of the analysis. And, for example, when the classifiers 110-1 through 110-n are applied to a speaker verification apparatus, each of the classifiers 110-1 through 110-n receives probe voice data and gallery voice data, analyzes the features of the probe voice data and the gallery voice data, and calculates a score indicating how similar the probe voice data is to the gallery voice data according to the results of the analysis.

The classifiers 110-1 through 110-n may analyze the features of input data using different methods. When the classifiers 110-1 through 110-n use different methods to analyze the features of input data, a plurality of scores respectively output by the classifiers 110-1 through 110-n can be complementary to one another, and a high-performance classifier can be realized by fusing the plurality of scores. For example, assuming that there are two classifiers using a face recognition algorithm, one of the two classifiers analyzing features of a high-resolution face image and the other classifier analyzing features of a low-resolution face image, the results of the analysis performed on the low-resolution face image are relatively robust against variations in the facial expression or blurriness, whereas the results of the analysis performed on a high-resolution face image enable analysis of detailed facial features. Therefore, it is possible to realize a precise face recognition apparatus by integrating the results of the analysis performed on the low-resolution face image and the results of the analysis performed on the high-resolution face image.

The fusion unit 120 fuses the scores respectively obtained by the classifiers 110-1 through 110-n, thereby obtaining a final score. Then, the fusion unit 120 outputs the final score. The fusion unit 120 may fuse the scores respectively obtained by the classifiers 110-1 through 110-n using a likelihood ratio, and this will hereinafter be described in detail.

Assume that the scores respectively output by the classifiers 110-1 through 110-n are S₁ through Sₙ. When the scores S₁ through Sₙ are input, it must be determined whether the scores S₁ through Sₙ originate from a probe-gallery pair that render the same object or from a probe-gallery pair that render different objects. For this, hypotheses H₀ and H₁ can be established as indicated by Equation (1):

H₀: S₁, . . . , Sₙ˜p(s₁, . . . , sₙ|diff), (1)

H₁: S₁, . . . , Sₙ˜p(s₁, . . . , sₙ|same)

Here, p(s₁, . . . , sₙ|diff) represents the density of the scores S₁ through Sₙ when the probe and gallery are from different objects, and p(s₁, . . . , sₙ|same) represents the density of the scores S₁ through Sₙ when the probe and gallery are from the same object. If the densities p(s₁, . . . , sₙ|diff) and p(s₁, . . . , sₙ|same) are known, a log-likelihood ratio test may result in the highest verification rate that satisfies a given false acceptance rate (FAR) according to the Neyman-Pearson Lemma. The Neyman-Pearson Lemma is taught by T. M. Cover and J. A. Thomas in an article entitled “Elements of Information Theory”. The log-likelihood ratio test may be represented by Equation (2):

$$log \frac{p ( {s}_{1} , … , {s}_{n} \vert same )}{p ( {s}_{1} , … , {s}_{n} \vert diff )} > < 0. \qquad ( 2 )$$

Even if the densities p(s₁, . . . , sₙ|diff) and p(s₁, . . . , sₙ|same) are unknown, the densities p(s₁, . . . , sₙ|diff) and p(s₁, . . . , sₙ|same) can be estimated using a plurality of scores calculated for each of a plurality of probe-gallery pairs of learning data. The learning data is data that is input to the score fusion apparatus in advance to determine the distribution or density of the scores S₁ through Sₙ. The learning data may be stored in the storage unit 140.

In order to estimate the densities p(s₁, . . . , sₙ|diff) and p(s₁, . . . , sₙ|same), a nonparametric density estimation method such as a Parzen density estimation method can be used. The Parzen density estimation method is taught by E. Parzen in an article entitled “On Estimation of a Probability Density Function and Mode”. A method of integrating a plurality of classifiers using the Parzen density estimation method is taught by S. Prabhakar and A. K. Jain in an article entitled “Decision-Level Fusion in Fingerprint Verification”. According to the present embodiment, a parametric density estimation may be used due to high computational complexity and a potential risk of overfitting of a nonparametric density estimation method.

{Sᵢ}ᵢ₌₁ⁿ can be modeled given H₀ as independent Gaussian random variables with the density defined by Equation (3):

p(s₁, . . . ,sₙ|diff)=ΠN(sᵢ;m_{diff,i}σ_{diff,i}) (3)

Here, m_{diff,i} is the mean of a plurality of scores obtained by the i-th classifier using a plurality of probe-gallery pairs which render different objects, and σ_{diff,i} is the standard deviation of the plurality of scores. The plurality of probe-gallery pairs used to obtain m_{diff,i} and σ_{diff,i} are learning data that is obtained through experiments conducted in advance and is input to the score fusion apparatus.

A Gaussian density function N(sᵢ; m , σ) in Equation (3) can be indicated by Equation (4):

$$N ( {s}_{i} ; m , σ ) = \frac{1}{\sqrt{2 π} σ} exp \{ - \frac{{( {s}_{i} - m )}^{2}}{2 {σ}^{2}} \} . \qquad ( 4 )$$

Likewise, if {Sᵢ}ᵢ₌₁ⁿ in the hypothesis H₁ is modeled using independent Gaussian random variables, the density p(s₁, . . . , sₙ|same) can be defined by Equation (5):

p(s₁, . . . , sₙ|same)=ΠN(sᵢ;m_{same,i},σ_{same,i}) (5).

Here, m_{same,i} is the mean of a plurality of scores obtained by the i-thclassifier using a plurality of probe-gallery pairs which render the same object, and σ_{same,i} is the standard deviation of the plurality of scores. The plurality of probe-gallery pairs used to obtain m_{same,i} and σ_{same,i} are learning data that is obtained through experiments conducted in advance and is input to the score fusion apparatus.

A Gaussian density function N(sᵢ; m , σ) in Equation (5), like the Gaussian density function N(sᵢ; m , σ) in Equation (3), can be defined by Equation (4).

Accordingly, the fusion unit 120 can fuse the scores respectively obtained by the classifiers 110-1 through 110-n using a log-likelihood ratio, as indicated by Equation (6):

$$\begin{matrix}S = log \frac{{\prod }_{i = 1}^{n} N ( {S}_{i} ; {m}_{same , i} , {σ}_{same , i} )}{{\prod }_{i = 1}^{n} N ( {S}_{i} ; {m}_{diff , i} , {σ}_{diff , i} )} \\ = {\sum }_{i = 1}^{n} ( \frac{{( {S}_{i} - {m}_{diff , i} )}^{2}}{2 {σ}_{diff , i}^{2}} - \frac{{( {S}_{i} - {m}_{same , i} )}^{2}}{2 {σ}_{same , i}^{2}} ) + c .\end{matrix} \qquad ( 6 )$$

Here, S represents a final score output by the fusion unit 140, and c is a constant. The constant c does not affect the performance of face recognition, and can thus be excluded from the calculation of the final score S.

Alternatively, the fusion unit 120 may fuse the scores respectively obtained by the classifiers 110-1 through 110-n according to equal error rates (EERs) of the classifiers 110-1 through 110-n, and this will hereinafter be described in detail.

When the scores respectively obtained by the classifiers 110-1 through 110-n are input to the fusion unit 120, the fusion unit 120 may calculate the final score S using a weighted summation method, as indicated by Equation (7):

$$S = {\sum }_{i = 1}^{n} {w}_{i} {s}_{i} . \qquad ( 7 )$$

Here, Sᵢ represents a score obtained by the i-th classifier, wᵢ represents a weight value applied to the score Sᵢ, n represents the number of scores respectively obtained by the classifiers 110-1 through 110-n, i.e., the number of classifiers 110-1 through 110-n, and S represents the final score output by the fusion unit 120.

The weight value wᵢ may be set according to the environment to which the score fusion apparatus is applied in such a manner that a weight value allocated to a score obtained by a classifier that is expected to achieve high performance is higher than a weight value allocated to a score obtained by a classifier that is expected to achieve low performance. In other words, the weight value wᵢ may be interpreted as reliability of the i-th classifier.

According to the present embodiment, an ERR-based weighted summation method is used to appropriately determine the weight value wᵢ. ERR is an error rate occurring when false rejection rate and false acceptance rate obtained when performing classification on input data using the classifiers 110-1 through 110-n separately become equal. The ERR of each of the classifiers 110-1 through 110-n may be determined by testing the performance of each of the classifiers 110-1 through 110-n using a plurality of probe-gallery pairs, i.e., learning data.

The higher the performance of a classifier is, the lower the EER of the classifier becomes. Thus, the inverse of EER of a classifier may be used as a weight value applied to the classifier. In this case, the fusion unit 120 may fuse the scores respectively obtained by the classifiers 110-1 through 110-n, as indicated by Equation (8):

$$S = {\sum }_{i = 1}^{n} \frac{{s}_{i}}{{EER}_{i}} . \qquad ( 8 )$$

### Here, EERᵢ represents EER of the i-th classifier.

The parameter providing unit 130 provides the fusion unit 120 with a plurality of parameters needed for fusing the scores respectively obtained by the classifiers 110-1 through 110-n. For example, if the fusion unit 120 fuses the scores respectively obtained by the classifiers 110-1 through 110-n, as indicated by Equation (6), the parameter providing unit 130 may provide the fusion unit 120 with m_{diff,i}, σ_{diff,i}, m_{same,i}, and σ_{same,i}. Alternatively, if the fusion unit 120 fuses the scores respectively obtained by the classifiers 110-1 through 110-n using an EER-based weighted summation method, as indicated by Equation (8), the parameter providing unit 130 may provide the fusion unit 120 with EERᵢ.

For this, the parameter providing unit 130 may calculate a plurality of parameters using a plurality of scores obtained by each of the classifiers 110-1 through 110-n using a plurality of probe-gallery pairs of learning data stored in the storage unit 140. The parameters needed by the fusion unit 120 may be calculated in advance through experiments, and the results of the calculation may be stored in the storage unit 140. In this case, the parameter providing unit 130 may provide the fusion unit 120 with the parameters stored in the storage unit 140.

The classifiers 110-1 through 110-n, the fusion unit 120, the parameter providing unit 130, and the storage unit 140 of the score fusion apparatus illustrated in FIG. 1 may be realized as modules. Here, the term “module” means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

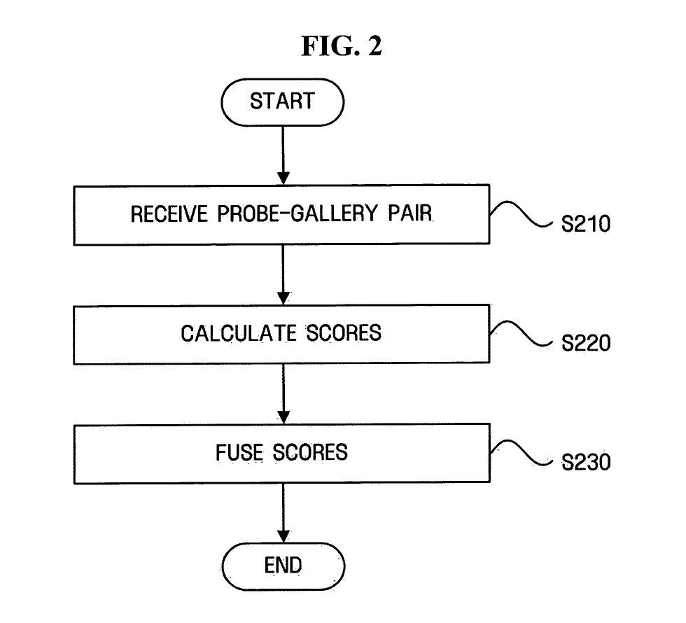

FIG. 2 is a flowchart illustrating a score fusion method according to an embodiment of the present invention. The score fusion method illustrated in FIG. 2 is, for ease of explanation only, described with concurrent reference to the apparatus of FIG. 1.

Referring to FIG. 2, in operation S210, data (a probe-gallery pair) is input. In operation S220, each of the classifiers 110-1 through 110-n analyzes the input probe-gallery pair, and calculates a score according to the results of the analysis.

In operation S230, the fusion unit 120 fuses the scores respectively output by the classifiers 110-1 through 110-n. In detail, in operation S230, the fusion unit 120 may fuse the scores respectively output by the classifiers 110-1 through 110-n using a log-likelihood ratio, as indicated by Equation (6), or using an EER-based weighted summation method, as indicated by Equation (8). A plurality of parameters needed for fusing the scores respectively output by the classifiers 110-1 through 110-n may be provided by the parameter providing module 130.

In this manner, the score fusion apparatus may function as a single classifier.

Embodiments of the present invention can be written as code/instructions/computer programs and can be implemented in general-use digital computers that execute the code/instructions/computer programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet). The computer readable recording medium can also be distributed over network coupled computer systems so that the computer readable code is stored and executed in a distributed fashion.

According to the above-described embodiments of the present invention, it is possible to perform score fusion that is optimized from the viewpoint of probability theory and accompanies less computation.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A score fusion method comprising:
receiving a plurality of scores respectively obtained by a plurality of classifiers; and
fusing the received scores using a likelihood ratio between a distribution of first scores obtained by each of the classifiers using a plurality of input data that render a same object and a distribution of second scores obtained by each of the classifiers using a plurality of input data that render different objects.

2. The score fusion method of claim 1, wherein the fusing comprises fusing the received scores according to the following equation:
$${\sum }_{i = 1}^{n} ( \frac{{( {S}_{i} - {m}_{diff , i} )}^{2}}{2 {σ}_{diff , i}^{2}} - \frac{{( {S}_{i} - {m}_{same , i} )}^{2}}{2 {σ}_{same , i}^{2}} ) ,$$
and
wherein n represents a number of received scores, Sᵢ represents a score obtained by an i-th classifier of the classifiers, m_{diff,i} represents a mean of the second scores, σ_{diff,i} represents a standard deviation of the second scores, m_{same,i} represents a mean of the first scores, and σ_{same,i} represents a standard deviation of the first scores.

3. A score fusion apparatus comprising:
a fusion unit which receives a plurality of scores respectively obtained by a plurality of classifiers and fuses the received scores using a likelihood ratio between a distribution of first scores obtained by each of the classifiers using a plurality of input data that render a same object and a distribution of second scores obtained by each of the classifiers using a plurality of input data that render different objects; and
a parameter providing unit which provides the fusion unit with a plurality of parameters needed for fusing the received scores.

4. The score fusion apparatus of claim 3, wherein the fusing unit fuses the received scores according to the following equation:
$${\sum }_{i = 1}^{n} ( \frac{{( {S}_{i} - {m}_{diff , i} )}^{2}}{2 {σ}_{diff , i}^{2}} - \frac{{( {S}_{i} - {m}_{same , i} )}^{2}}{2 {σ}_{same , i}^{2}} ) ,$$
and
wherein n represents a number of received scores, Sᵢ represents a score obtained by an i-th classifier of the classifiers, m_{diff,i} represents a mean of the second scores, σ_{diff,i} represents a standard deviation of the second scores, m_{same,i} represents a mean of the first scores, and σ_{same,i} represents a standard deviation of the first scores.

5. A score fusion method comprising:
receiving a plurality of scores respectively obtained by a plurality of classifiers; and
fusing the received scores using a weighted summation based on equal error rates (EERs) of the classifiers.

6. The score fusion method of claim 7, wherein the fusing comprises fusing the received scores as indicated by the following equation:
$${\sum }_{i = 1}^{n} \frac{{s}_{i}}{{EER}_{i}} ,$$
and
wherein n represents a number of received scores, Sᵢ represents a score obtained by an i-th classifier of the classifiers, and EERᵢ represents an EER of the i-th classifier.

7. A score fusion apparatus comprising:
a fusion unit which receives a plurality of scores respectively obtained by a plurality of classifiers and fuses the received scores according to weighted summation based on equal error rates (EERs) of the classifiers; and
a parameter providing unit which provides the EERs of the classifiers.

8. The score fusion apparatus of claim 9, wherein the fusion unit fuses the received scores according to the following equation:
$${\sum }_{i = 1}^{n} \frac{{s}_{i}}{{EER}_{i}} ,$$
and
wherein n represents a number of received scores, Sᵢ represents a score obtained by an i-th classifier of the classifiers, and EERᵢ represents an EER of the i-th classifier.

9. A score fusion apparatus comprising:
a plurality of classifiers, each classifier respectively analyzing features of input reference data and input test data and calculating a score, based on a comparison of results of the analysis,indicating how similar the reference data is to the test data; and
a fusion unit fusing the plurality of scores to yield a final score using a likelihood ratio or using a weighted summation based on equal error rates (EERs) of the classifiers.

10. The apparatus of claim 9, wherein at least some of the plurality of classifiers use different methods to analyze the input reference and test data so that the scores output from the plurality of classifiers are complimentary and yield greater performance than a highest performance one of the plurality of classifiers.

11. The apparatus of claim 9, further comprising a parameter providing unit providing parameters usable by the fusing unit.

12. The apparatus of claim 11, wherein the parameter providing unit calculates the parameters using the plurality of scores obtained by each of the classifiers.

13. The apparatus of claim 9, wherein the fusing unit uses an inverse of the EER of each classifier as a weight value in the weighted summation.

14. A method of integrating a plurality of classifiers each of which analyzes features of input data and calculating a score indicating a similarity of the data, the method comprising:
fusing the plurality of scores to yield a final score using a likelihood ratio between a distribution of first scores obtained by each of the classifiers using a plurality of input data that render a same object and a distribution of second scores obtained by each of the classifiers using a plurality of input data that render different objects or using a weighted summation based on equal error rates (EERs) of the classifiers.

15. A computer-readable storage medium encoded with processing instructions for causing a processor to execute the method of claim 1.

16. A computer-readable storage medium encoded with processing instructions for causing a processor to execute the method of claim 5.

17. A computer-readable storage medium encoded with processing instructions for causing a processor to execute the method of claim 14.
